(19) United States
(12) Patent Application Publication
(10) Pub. No.: US 2012/0324485 A1
(43) Pub. Date: Dec. 20, 2012

(54) OPTICAL DISK DRIVE

(75) Inventors: XUE-DONG TANG, Shenzhen City (CN); WEI LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/207,701

(22) Filed: Aug. 11, 2011

(30) Foreign Application Priority Data
Jun. 15, 2011 (CN) 201110159779.8

(51) Int. Cl. G11B 17/04

(52) U.S. Cl. 720/601; G9B/17.013

(57) ABSTRACT

An optical disk drive includes a housing, a tray, a detecting switch, a slide actuating member, and a restricting structure. The tray is received in the housing for carrying a disk and is slidable relative to the housing to interchange between a closed position and an open position. The detecting switch is disposed in the housing for being actuated and detecting the position of the tray. The slide actuating member slidably engages with the housing and is capable of actuating the detecting switch under the drive of the tray. The restricting structure is disposed between the tray and the slide actuating member for restricting the slide actuating member from disengaging from the tray after the detecting switch is actuated.

### BACKGROUND

1. Technical Field

The present disclosure relates to optical disk drives, and particularly to an optical disk drive with a restricting structure.

2. Description of Related Art

Many optical disk drives include a tray for holding a disk thereon received in the housing and being slidable relative to the housing, a detecting switch for detecting the position of the tray, and a slide actuating member engaging with the tray for actuating the detecting switch. When the tray slides out of the housing, one end of the tray remains in the housing while an opposite end extends out of the housing. Any force or constant pressure applied on the extended end can cause the end remaining in the housing to rise up and disengage the slide actuating member from the tray.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a perspective view of an optical disk drive in accordance with an exemplary embodiment, and the optical disk drive includes a restricting structure.

FIG. 2 is an exploded view of the optical disk drive of FIG. 1.

FIG. 3 is similar to FIG. 1 but from a reverse angle.

FIG. 4 is an exploded view of the optical disk drive of FIG. 3.

FIG. 5 is a schematic view of the restricting structure of FIG. 1.

### DETAILED DESCRIPTION

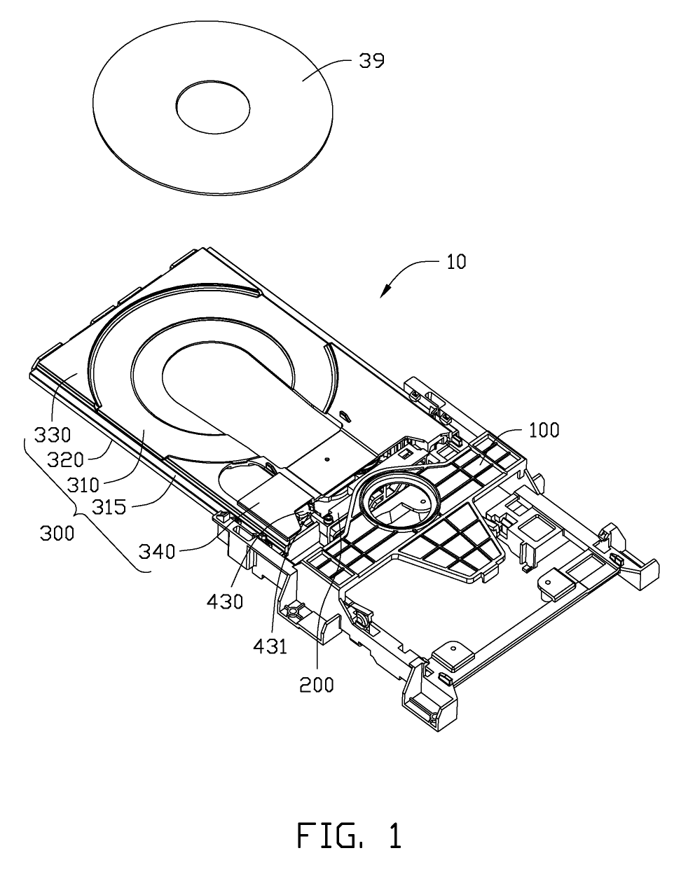

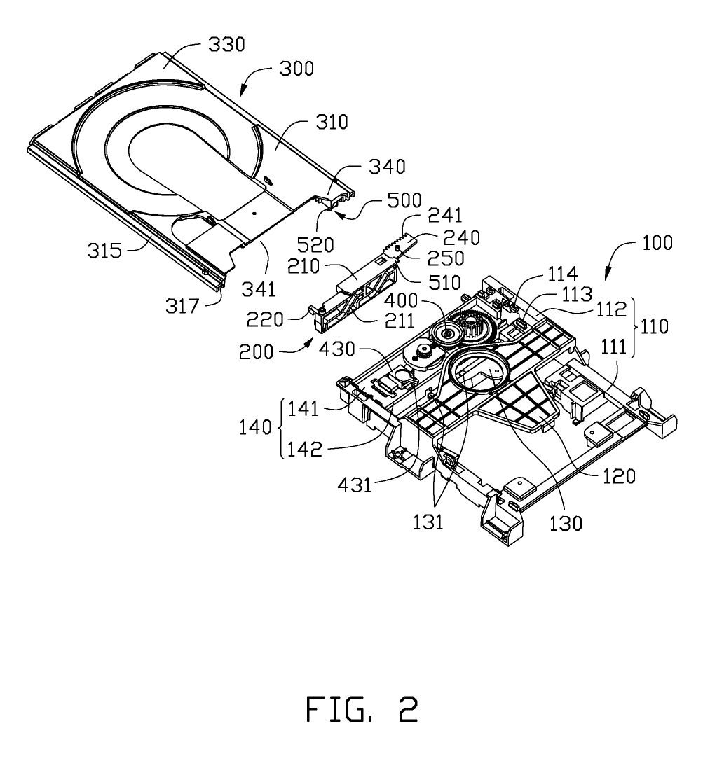

Referring to FIGS. 1 and 2, an optical disk drive 10 includes a housing 100, a slide actuating member 200, a tray 300, a driving assembly 400, a detecting switch 430, and a restricting structure 500. The tray 300 is slidably mounted to the housing 100 and is capable of interchanging between an open position and closed position under the drive of the driving assembly 400. When the tray 300 is in an open position, one end thereof extends out of the housing 100; and when the tray 300 is in a closed position, the tray 300 is totally received in the housing 100. The detecting switch is disposed in the housing 100 for being actuated to detect the position of the tray 300. The slide actuating member 200 slidably engages with the housing 100 and is capable of actuating the detecting switch 430 under the drive of the tray 300.

The housing 100 includes a frame 110, a bracket 120, a connection member 130, and a support member 140. As shown in FIG. 2, the frame 110 includes two beams 111, and two stopping arms 112 respectively protruding upwards from the beams 111. A number of guiding blocks 113 protrude up from each beam 111 for guiding the tray 300 to slide relative to the housing 100. Two stoppers 114 located above the corresponding beam 111 protrude from one side of each stopping arm 112 which faces the other stopping arm 112. The bracket 120 and the connection member 130 are connected to the frame 110 for connecting a spindle (not shown) of the optical disk drive 10 thereto. The connection member 130 includes two sliding rods 131. The support member 140 is disposed between the two beams 111 and is connected to both the two beams 111 for supporting the driving assembly 140, with one side thereof adjacent to the connection member 130. The support member 140 includes a bottom plate 141 connected to both of the beams 111 and an engaging portion 142 protruding from the bottom plate 141 along a direction opposite to the protruding direction of the guiding blocks 113 on each beam 111.

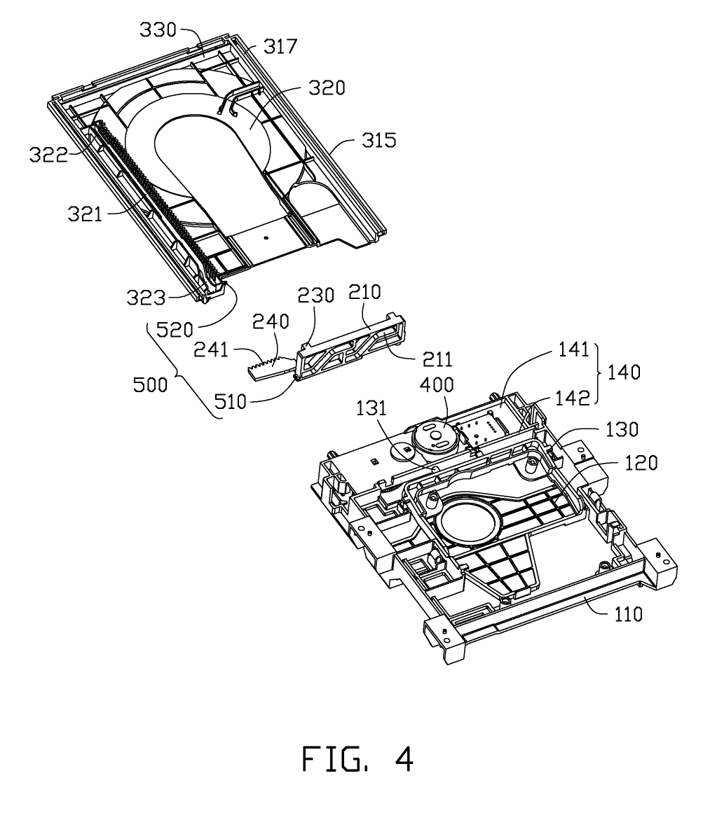

Referring to FIG. 1 again, the slide actuating member 200 is connected and slidable relative to the engaging portion 142. As shown in FIG. 2, the slide actuating member 200 includes a main body 210, two actuating arms 220, two hooks 230 (see FIG. 4), an extending portion 240, and a guiding post 250. The main body 210 is connected to the engaging portion 142 and corresponds to the connection member 130. One side of the main body 210 facing the connection member 130 defines two sliding slots 211 for receiving the sliding rods 131. The actuating arm 220 protrudes perpendicularly from one side of the main body 210 which is opposite to the sliding slots 211. As shown in FIG. 4, the hooks 230 protrude from the side of the main body 210 from which the actuating arm 220 protrudes and are substantially L shaped for hooking onto the engaging portion 142 to connect the main body 210 to the engaging portion 142. The extending portion 254 protrudes from the main body 210 and is engagable with the driving assembly 400. A number of convexities 241 are formed in the extending portion 240 to mesh with the driving assembly 400. The guiding post 250 protrudes from one side of the extending portion 240 which is away from the bottom plate 141.

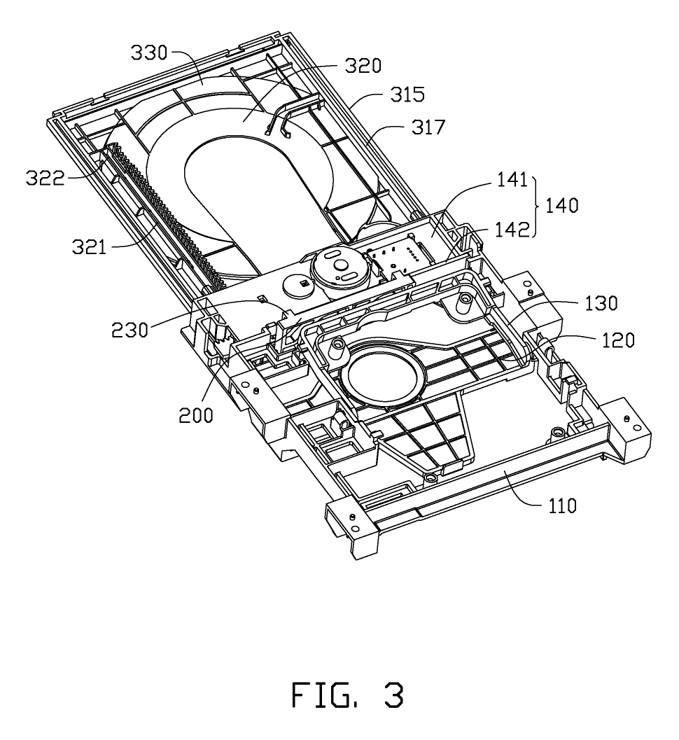

Referring to FIGS. 1 and 3, the tray 300 includes a first surface 310 contacting the disk 39, a second surface 320 opposite to the first surface 310, two flanges 315 connecting the first surface 310 to the second surface 320, a first end 330, and a second end 340 opposite to the first end 330. A guiding slot 321 is defined in the second surface 320 and is adjacent to one flange 315 for the guiding post 250 of the slide actuating member 200 to be inserted therein. As shown in FIG. 4, the guiding slot 321 includes an entrance portion 322 adjacent to the first end 330 and a curved portion 323 adjacent to the second end 340. Sidewalls of the curved portion 323 are curved towards the adjacent flange 315 along a first direction. The flanges 315 correspond to the beams 111 respectively and cover the beams 111 when the tray 300 is in the closed position.

Each flange 315 is clasped between the corresponding beams 111 and the stoppers 114 of the corresponding stopping arm 112 such that the tray 300 cannot escape from the housing 100. Each flange 315 is formed to be U shaped to define a guiding track 317 to receive the guiding blocks 113 of the corresponding beam 111. When the tray 300 slides relative to the housing 100, the guiding blocks 113 of the corresponding beam 111 slide in the corresponding guiding track 317 to guide the tray 300. The first end 330 extends out of the housing 10 while the second end 330 is just above the slide actuating member 200 when the tray 300 in the open position. A depression 341 is defined in the second end 340 of the tray 300 and corresponds to the slide actuating member 200.

The detecting switch 430 includes a swaying arm 431 corresponding to the actuating arm 230 of the slide actuating member 200. The swaying arm 431 is rotatable from an initial position to an actuating position when applied with a driving force from the actuating arm 230 and is capable of returning to the initial position from the actuating position when the outer force is removed. When rotating from the actuating position to the initial position, the swaying arm 431 applies a counterforce opposite to the driving force to the actuating arm 230. When the swaying arm 431 lies in the actuating position, a position signal of the tray 300 is sent to a control center (not shown) of the optical disk drive 10 from the detecting switch 430.

When the tray 300 is in the closed position, the tray 300 is totally received in the housing 100 and the guiding post 250 of the slide actuating member 200 is not inserted in the guiding slot 321. When the optical disk drive 10 begins to work, the slide actuating member 200 is driven to move along the first direction relative to the engaging portion 142 of the support member 140 with the engagement between the extending portion 240 and the driving assembly 400. At this time, the actuating arm 220 is adjacent to the swaying arm 431 of the detecting switch 430 but is still spaced from the swaying arm 431. After the guiding post 250 enters into the guiding slot 321, the tray 300 begins to slide relative to the housing 100 with the engagement between the pinion rack 318 and the driving assembly 400. As the tray 300 slides relative to the housing 100, the guiding post 250 gets closer to the curved portion 323 of the guiding slot 321.

When the guiding post 250 slides to the curved portion 323, the tray 300 is substantially in the open position. At this time, the sidewalls of the curved portion 323 apply a moving force along the first direction to the guiding post 250, driving the slide actuating member 200 to move further along the first direction to contact the swaying arm 431. The actuating arm 230 thus drives the swaying arm 431 to rotate to the actuating position from the initial position. Therefore, the detecting switch 430 is actuated and the position signal of the tray 300 is sent to a control center of the optical disk drive 10 to indicate the position of the tray 300. After the position signal is sent, the swaying arm 431 returns to the initial position and applies the counterforce opposite to the moving force to the actuating arm 230.

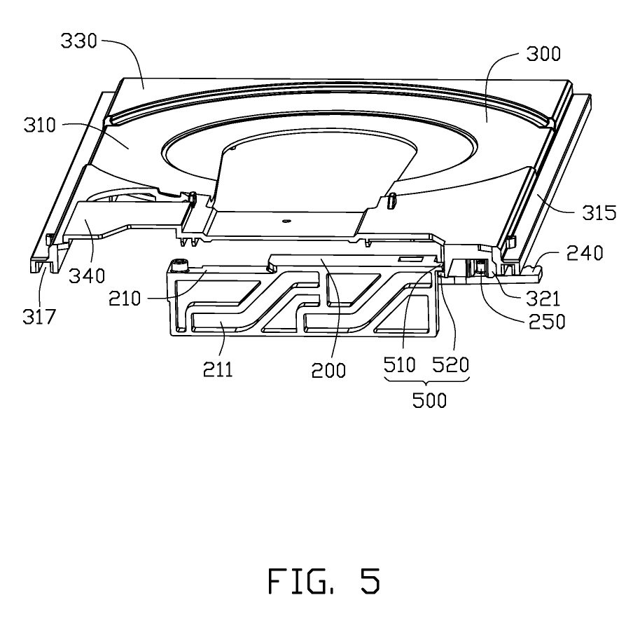

Referring to FIGS. 2 and 4, the restricting structure 500 includes a first restricting portion 510 disposed in the main body 210 of the slide actuating member 200, and a second restricting portion 520 disposed on the tray 300 for engaging with the first restricting portion 510. The first restricting portion 510 protrudes from one side of the main body 210 and is adjacent to the extending portion 240. The second restricting portion 520 protrudes from the tray 300 and partly extends into the depression 341. When the tray 300 is in the open position, the first restricting portion 510 is located above the second restricting portion 520 as shown in FIG. 5, restricting the second restricting portion 520 and the second end 340 of the tray 300 from moving upwards. Therefore, even when the first end 330 is pushed by an outer force, the second end 340 cannot be raised up and the guiding post 250 cannot escape from the guiding slot 321.

With the restricting structure 500, the second end 340 of the tray 300 may not be easily raised up even when the first end 330 is pushed down, and the guiding post 250 is prevented from coming loose from the guiding slot 321 and the slide actuating member 200 will not in turn be disengaged from the tray 300.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An optical disk drive, comprising:
a housing;
a tray received in the housing for carrying a disk and being slidable relative to the housing to interchange between a closed position and an open position;
a detecting switch disposed in the housing for being actuated to detect the position of the tray;
a slide actuating member slidably engaging with the housing and being capable of actuating the detecting switch under the drive of the tray; and
a restricting structure disposed between the tray and the slide actuating member for restricting the slide actuating member from disengaging from the tray after the detecting switch is actuated.

2. The optical disk drive as claimed in claim 1, wherein one guiding slot is defined in the tray, the slide actuating member comprises a guiding post inserted into the guiding slot, and the restricting structure is used for restricting the guiding post from escaping from the guiding slot.

3. The optical disk drive as claimed in claim 2 wherein the slide actuating member is capable of applying a driving force to the detecting switch to actuate the detecting switch, and the detecting switch is capable of applying a counterforce opposite to the driving force to the slide actuating member after being actuated.

4. The optical disk drive as claimed in claim 3, wherein the detecting switch comprises a swaying arm rotatable between an initial position and an actuating position under the driving force, when the swaying arm rotates from the initial position to the actuating position, the detecting switch is actuated, and when the swaying arm rotates from the actuating position to the initial position, the counterforce is applied to the slide actuating member.

5. The optical disk drive as claimed in claim 2, wherein the guiding slot extends along a first direction from the closed position to the open position.

6. The optical disk drive as claimed in claim 5, wherein the guiding slot comprises a curved portion, the curved portion comprises two opposite curved side walls being curved towards one side of the tray, the guiding slot applies a moving force to drive the slide actuating member to slide relative to the housing towards the detecting switch by the side walls of the curved portion.

7. The optical disk drive as claimed in claim 2, wherein the restricting structure comprises a first restricting portion disposed on the slide actuating member and a second restricting portion disposed on the tray for engaging with the first restricting portion.

8. The optical disk drive as claimed in claim 7, wherein the tray comprises a first end and a second end opposite to the first end, when the tray is in the open position, the first end extends out of the housing and the second end corresponds to the slide actuating member, the second restricting portion is disposed adjacent to the second end.

9. The optical disk drive as claimed in claim 1, wherein the optical disk drive further comprises a driving assembly for driving the tray to slide relative to the housing, the slide actuating member comprises an extending portion defining a plurality of convexes, the slide actuating member is driven to move towards the detecting switch for a predetermined position with the engagement between the convexes and the driving assembly.

10. The optical disk drive as claimed in claim 1, wherein the housing comprising two opposite beams with a plurality of guiding blocks protruding therefrom, the tray comprising two opposite flanges corresponding to the beams respectively, each flange defines a guiding track for inserting the guiding blocks of each beam therein, when the tray slides relative to the housing, the guiding blocks slide in the guiding slots to guide the tray.

11. The optical disk drive as claimed in claim 10, wherein the housing further comprises two stopping arms protruding from the beams respectively, a plurality of stoppers protruding from each stopping arm for engaging with the corresponding beam to clasp the tray in the housing.

12. An optical disk drive, comprising:
a housing;
a tray slidable relative to the housing to interchange between a closed position and an open position, the tray comprising:
a first end being extending out of the housing when the tray is in the open position;
a second end opposite to the first end;
a detecting switch being actuated for detecting the position of the tray;
a slide actuating member for actuating the detecting switch and corresponding to the second end of the tray when the tray is in the open position;
a restricting structure for preventing the second end from being raised up relative to the housing and disengaging from the slide actuating member when the first end is pushed.

13. The optical disk drive as claimed in claim 12, wherein the tray defines a guiding slot, the slide actuating member comprises a guiding post being inserted in the guiding slot, the restricting structure restricts the guiding post from escaping from the guiding slot when the second end is raised up.

14. The optical disk drive as claimed in claim 13, wherein the guiding slot extends parallel to the moving direction of the tray from the closed position to the open position, the guiding slot comprises a curved portion with side walls thereof being curved towards a side of the tray.

15. The optical disk drive as claimed in claim 14, wherein when the tray is in the open position, the guiding post lies in the curved portion, the side walls of the curved portion applies a moving force to the guiding post to drive the slide actuating member to slide towards the detecting switch.

16. The optical disk drive as claimed in claim 15, wherein the slide actuating member is capable of applying a driving force to the detecting switch to actuate the detecting switch, and the detecting switch is capable of applying a counterforce opposite to the driving force to the slide actuating member after being actuated.

17. The optical disk drive as claimed in claim 16, wherein the detecting switch comprises a swaying arm rotatable between an initial position and an actuating position under the driving force, when the swaying arm rotates from the initial position to the actuating position, the detecting switch is actuated, and when the swaying arm rotates from the actuating position to the initial position, the counterforce is applied to the slide actuating member.

18. The optical disk drive as claimed in claim 12, wherein the restricting structure comprises a first restricting portion disposed on the tray and a second restricting portion disposed on the slide actuating member for restricting the first restricting portion from moving relative to the housing.

19. The optical disk drive as claimed in claim 18, wherein the second restricting portion is located above the first restricting portion when the tray is in the open position.
